(19) United States
(12) Patent Application Publication
(10) Pub. No.: US 2021/0158409 A1
(43) Pub. Date: May 27, 2021

(54) INFORMATION OUTPUT METHOD AND ASSIST DEVICE FOR CONSTRUCTION MACHINE

(71) Applicant: SUMITOMO HEAVY INDUSTRIES, LTD., Tokyo (JP)

(72) Inventor: Kesaaki MINEMURA, Kanagawa (JP)

(21) Appl. No.: 17/142,421

(22) Filed: Jan. 6, 2021

Related U.S. Application Data
(63) Continuation of application No. PCT/JP2019/027423, filed on Jul. 10, 2019.

(30) Foreign Application Priority Data
Jul. 10, 2018 (JP) 2018-131040

(51) Int. Cl. G06Q 30/02; E02F 9/26; G07C 5/04

(52) U.S. Cl. CPC G06Q 30/0283; E02F 9/2285; G07C 5/04; E02F 9/26

(57) ABSTRACT

According to an aspect of the present invention, an information output method for a construction machine executed by one or more hardware processors includes detecting the condition of an inspection target of the construction machine with an information obtaining device. The cumulative operating time of the inspection target or the diagnosis result of the condition of the inspection target is determined based on the detection result. A maintenance price associated with the cumulative operating time or the diagnosis result is determined and output.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2019/027423, filed on Jul. 10, 2019 and designating the U.S., which claims priority to Japanese patent application No. 2018-131040, filed on Jul. 10, 2018. The entire contents of the foregoing applications are incorporated herein by reference.

### BACKGROUND

### Technical Field

The present disclosure relates to information output methods and assist devices for construction machines.

### Description of Related Art

A method of performing failure diagnosis based on the operating information of a shovel serving as a construction machine is known.

### SUMMARY

According to an aspect of the present invention, an information output method for a construction machine executed by one or more hardware processors includes detecting the condition of an inspection target of the construction machine with an information obtaining device. The cumulative operating time of the inspection target or the diagnosis result of the condition of the inspection target is determined based on the detection result. A maintenance price associated with the cumulative operating time or the diagnosis result is determined and output.

### BRIEF DESCRIPTION OF THE DRAWINGS

FIG. 1 is a diagram illustrating an example configuration of a system according to an embodiment;

FIG. 2 is a diagram illustrating an example configuration of the system according to the embodiment;

FIG. 3 is a diagram illustrating an example of a display screen according to the embodiment;

FIG. 4 is a diagram illustrating an example of a display screen according to another embodiment;

FIG. 5 is a flowchart of a process executed by a diagnosis part;

FIG. 6 is a graph illustrating part of an evaluation waveform;

FIG. 7 is a graph illustrating an example of a distribution of normalized reference vectors and a normalized evaluation vector;

FIG. 8 is a diagram illustrating another example of the display screen;

FIG. 9 is a diagram illustrating yet another example of the display screen;

FIG. 10 is a diagram illustrating still another example of the display screen; and

FIG. 11 is a flowchart of an information output method for a construction machine according to an embodiment of the present invention.

### DETAILED DESCRIPTION

According to a known method of performing failure diagnosis based on the operating information of a shovel serving as a construction machine, while it is possible to perform failure diagnosis, there is a problem in that a user cannot determine when is an appropriate time to perform maintenance on the shovel. Furthermore, there is also a problem in that a user cannot determine the effect of an abnormality.

According to an aspect of the present invention, an information output method and an assist device for a construction machine that assist a user in determining the timing of maintenance are provided.

One or more embodiments are described below with reference to the accompanying drawings. In the following description, the same components are referred to using the same reference numeral, and a duplicate description thereof may be omitted.

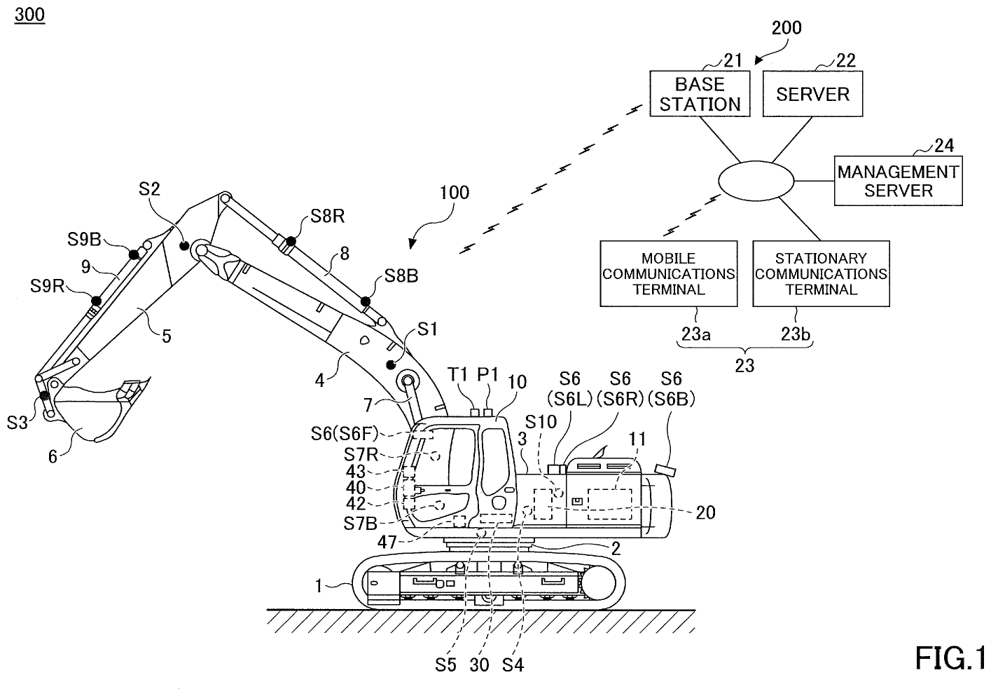

A maintenance support system 300 (appropriately referred to as “system 300”) according to an embodiment is described with reference to FIG. 1. FIG. 1 is a diagram illustrating an example configuration of the maintenance support system 300. The system 300 includes an excavator (a shovel 100) serving as a construction machine and a communications network 200. In the following description, the construction machine is described as an excavator (the shovel 100). The construction machine, however, is not limited to this, and may also be a bulldozer, a wheel loader, or the like.

An upper swing structure 3 is swingably mounted on an undercarriage 1 of the shovel 100 via a swing mechanism 2. A boom 4 is attached to the upper swing structure 3. An arm 5 is attached to the distal end of the boom 4. A bucket 6 serving as an end attachment is attached to the distal end of the arm 5.

The boom 4, the arm 5, and the bucket 6 constitute an excavation attachment that is an example of an attachment. The boom 4 is driven by a boom cylinder 7. The arm 5 is driven by an arm cylinder 8. The bucket 6 is driven by a bucket cylinder 9. A boom angle sensor S1 is attached to the boom 4. An arm angle sensor S2 is attached to the arm 5. A bucket angle sensor S3 is attached to the bucket 6. The boom angle sensor S1, the arm angle sensor S2, and the bucket angle sensor S3, which are used to identify the pose of the attachment, are also collectively referred to as “pose sensor.”

The boom angle sensor S1 detects the pivot angle of the boom 4. According to this embodiment, the boom angle sensor S1 is an acceleration sensor and can detect the pivot angle of the boom 4 relative to the upper swing structure 3 (hereinafter “boom angle”). For example, the boom angle is smallest when the boom 4 is lowest and increases as the boom 4 rises.

The arm angle sensor S2 detects the pivot angle of the arm 5. According to this embodiment, the arm angle sensor S2 is an acceleration sensor and can detect the pivot angle of the arm 5 relative to the boom 4 (hereinafter “arm angle”). For example, the arm angle is smallest when the arm 5 is most closed and increases as the arm 5 opens.

The bucket angle sensor S3 detects the pivot angle of the bucket 6. According to this embodiment, the bucket angle sensor S3 is an acceleration sensor and can detect the pivot angle of the bucket 6 relative to the arm 5 (hereinafter “bucket angle”). For example, the bucket angle is smallest when the bucket 6 is most closed and increases as the bucket 6 opens.

Each of the boom angle sensor S1, the arm angle sensor S2, and the bucket angle sensor S3 may alternatively be a potentiometer using a variable resistor, a stroke sensor that detects the stroke amount of a corresponding hydraulic cylinder, a rotary encoder that detects a pivot angle about a link pin, a gyroscope, an inertial measurement unit constituted of a combination of an acceleration sensor and a gyroscope, or the like.

A boom rod pressure sensor S7R and a boom bottom pressure sensor S7B are attached to the boom cylinder 7. An arm rod pressure sensor S8R and an arm bottom pressure sensor S8B are attached to the arm cylinder 8. A bucket rod pressure sensor S9R and a bucket bottom pressure sensor S9B are attached to the bucket cylinder 9. The boom rod pressure sensor S7R, the boom bottom pressure sensor S7B, the arm rod pressure sensor S8R, the arm bottom pressure sensor S8B, the bucket rod pressure sensor S9R, and the bucket bottom pressure sensor S9B are also collectively referred to as “cylinder pressure sensor.”

The boom rod pressure sensor S7R detects the pressure of the rod-side oil chamber of the boom cylinder 7 (hereinafter “boom rod pressure”). The boom bottom pressure sensor S7B detects the pressure of the bottom-side oil chamber of the boom cylinder 7 (hereinafter “boom bottom pressure”). The arm rod pressure sensor S8R detects the pressure of the rod-side oil chamber of the arm cylinder 8 (hereinafter “arm rod pressure”). The arm bottom pressure sensor S8B detects the pressure of the bottom-side oil chamber of the arm cylinder 8 (hereinafter “arm bottom pressure”). The bucket rod pressure sensor S9R detects the pressure of the rod-side oil chamber of the bucket cylinder 9 (hereinafter “bucket rod pressure”). The bucket bottom pressure sensor S9B detects the pressure of the bottom-side oil chamber of the bucket cylinder 9 (hereinafter “bucket bottom pressure”).

A vibration sensor S10 detects the vibration of a swing reducer 20. The vibration sensor S10, which is constituted of an acceleration sensor according to this embodiment, may also be an acoustic emission (AE) sensor using a piezoelectric element. The vibration sensor S10 is configured to be detachable and reattachable to the swing reducer 20 with a single touch so as to enable a periodic check on the swing reducer 20. The vibration sensor S10, however, may alternatively be fixed to the swing reducer 20 to be able to detect the vibration of the swing reducer 20 while the shovel 100 is in operation as well.

A cabin 10 that is a cab is provided and a power source such as an engine 11 is mounted on the upper swing structure 3. Furthermore, a controller 30, a display (output) device 40, an input device 42, an audio output device 43, a storage device 47, a positioning device P1, a machine body tilt sensor S4, a swing angular velocity sensor S5, an image capturing device S6, and a communications device T1 are attached to the upper swing structure 3.

The controller 30 operates as a main control part that controls the driving of the shovel 100. According to this embodiment, the controller 30 is constituted of a computer including a CPU, a RAM, and a ROM. One or more functions of the controller 30 are implemented by the CPU executing one or more programs stored in the ROM, for example.

The display device 40 displays information. The display device 40 may be connected to the controller 30 via a communications network such as a CAN or a dedicated line.

The input device 42 enables an operator to input information to the controller 30. The input device 42 includes one or more of a touchscreen, a knob switch, and a membrane switch installed in the cabin 10.

The audio output device 43 outputs audio and is connected to the controller 30. Examples of the audio output device 43 include an in-vehicle loudspeaker and an alarm such as a buzzer. According to this embodiment, the audio output device 43 outputs audio information in response to an audio output command from the controller 30.

The storage device 47 stores information. The storage device 47 is, for example, a nonvolatile storage medium such as a semiconductor memory. The storage device 47 may store information output by one or more devices while the shovel 100 is in operation or may store information obtained or input via one or more devices before the shovel 100 starts to operate. The storage device 47 may store data on an intended work surface obtained via the communications device T1 or the like, for example. The intended work surface may be set by the operator of the shovel 100 or set by a work manager or the like.

The positioning device P1 measures the position and the orientation of the upper swing structure 3. The positioning device P1 is, for example, a GNSS compass, and detects the position and the orientation of the upper swing structure 3 to output a detection value to the controller 30. Therefore, the positioning device P1 may operate as an orientation detector that detects the orientation of the upper swing structure 3. The orientation detector may be a direction sensor attached to the upper swing structure 3.

The machine body tilt sensor S4 detects the tilt of the upper swing structure 3 relative to a horizontal plane. According to this embodiment, the machine body tilt sensor S4 is an acceleration sensor that detects the tilt angle of the upper swing structure 3 about its longitudinal axis (“roll angle”) and the tilt angle of the upper swing structure 3 about its lateral axis (“pitch angle”). The longitudinal axis and the lateral axis of the upper swing structure 3 cross each other at right angles at a shovel central point that is a point on the swing axis of the shovel 100, for example. The machine body tilt sensor S4 may be an inertial measurement unit constituted of a combination of an acceleration sensor and a gyroscope.

The swing angular velocity sensor S5 detects the swing angular velocity and the swing angle of the upper swing structure 3. The swing angular velocity sensor S5, which is a gyroscope according to this embodiment, may also be a resolver, a rotary encoder, or the like.

The image capturing device S6 captures an image of an area surrounding the shovel 100. According to this embodiment, the image capturing device S6 includes a front camera S6F that captures an image of a space in front of the shovel 100, a left camera S6L that captures an image of a space to the left of the shovel 100, a right camera S6R that captures an image of a space to the right of the shovel 100, and a back camera S6B that captures an image of a space behind the shovel 100.

The image capturing device S6 is, for example, a monocular camera including an imaging device such as a CCD or a CMOS, and outputs a captured image to the display device 40. The image capturing device S6 may also be a stereo camera, a distance image camera, or the like.

The front camera S6F is attached to, for example, the ceiling of the cabin 10, namely, the inside of the cabin 10. The front camera S6F, however, may alternatively be attached outside the cabin 10, for example, to the roof of the cabin 10, the side of the boom 4, or the like. The left camera S6L is attached to the left end of the upper surface of the upper swing structure 3. The right camera S6R is attached to the right end of the upper surface of the upper swing structure 3. The back camera S6B is attached to the back end of the upper surface of the upper swing structure 3.

The communications device T1 controls communications with an external device outside the shovel 100. According to this embodiment, the communications device T1 controls communications with an external device via a satellite communications network, a cellular phone network, the Internet, or the like.

The communications network 200 includes a base station 21, a server 22, a communications terminal 23, and a management server 24. The communications terminal 23 includes a mobile communications terminal 23a and a stationary communications terminal 23b. The base station 21, the server 22, the communications terminal 23 and the management server 24 may be interconnected using communication protocols such as Internet protocols, for example. Each of the shovel 100, the base station 21, the server 22, the communications terminal 23, and the management server 24 may be one or more in number. Examples of the mobile communications terminal 23a include a notebook computer, a cellular phone, and a smartphone.

The base station 21 is an external facility that receives information transmitted by the shovel 100, and exchanges information with the shovel 100 through a satellite communications network, a cellular phone network, the Internet, or the like.

The server 22 operates as a management apparatus for the shovel 100. According to this embodiment, the server 22 is an apparatus installed in an external facility such as the office of a user who operates the shovel 100 or a management center, and stores and manages information transmitted by the shovel 100. The server 22 is, for example, a computer including a CPU, a ROM, a RAM, an input/output (I/O) interface, an input device, and a display. Specifically, the server 22 obtains and stores information received by the base station 21 through the communications network 200, and manages the stored information such that the operator (manager) can refer to the stored information on an as-needed basis.

The server 22 may also be configured to make one or more settings associated with the shovel 100 through the communications network 200. Specifically, the server 22 may transmit values with respect to one or more settings to the shovel 100 to change values with respect to the one or more settings stored in the controller 30.

The server 22 may transmit information on the shovel 100 to the communications terminal 23 through the communications network 200. Specifically, when a predetermined condition is satisfied or in response to a request from the communications terminal 23, the server 22 may transmit information on the shovel 100 to the communications terminal 23 to impart the information on the shovel 100 to an operator of the communications terminal 23.

The communications terminal 23 operates as an assist device for the shovel 100. According to this embodiment, the communications terminal 23 is a device that can refer to information stored in the server 22, and is, for example, a computer including a CPU, a ROM, a RAM, an I/O interface, an input device, and a display. The communications terminal 23 may be connected to the server 22 through the communications network 200 to enable the operator (manager) to view information on the shovel 100, for example. That is, the communications terminal 23 may also be configured to receive information on the shovel 100 transmitted by the server 22 and enable the operator (manager) to view the received information.

According to this embodiment, the server 22 manages information on the shovel 100 transmitted by the shovel 100. Therefore, the operator (manager) can view information on the shovel 100 through the display of the server 22 or the communications terminal 23 at a desired time.

The management server 24 operates as a price determining apparatus (assist device) that assists a user in determining the timing of maintenance of the shovel 100 by determining the maintenance price of the shovel 100. According to this embodiment, the management server 24 is, for example, an apparatus installed in an external facility such as a factory of a manufacturer that provides a maintenance service for the shovel 100, and determines the maintenance price of the shovel 100 based on information on the shovel 100 stored in the server 22. The management server 24 is, for example, a computer including a CPU, a ROM, a RAM, an I/O interface, an input device, and a display. The determined maintenance price may be viewed on the communications terminal 23, etc., through the communications network 200. This enables a user to suitably select the timing of maintenance of the shovel 100 based on the maintenance price displayed on the communications terminal 23 or the like.

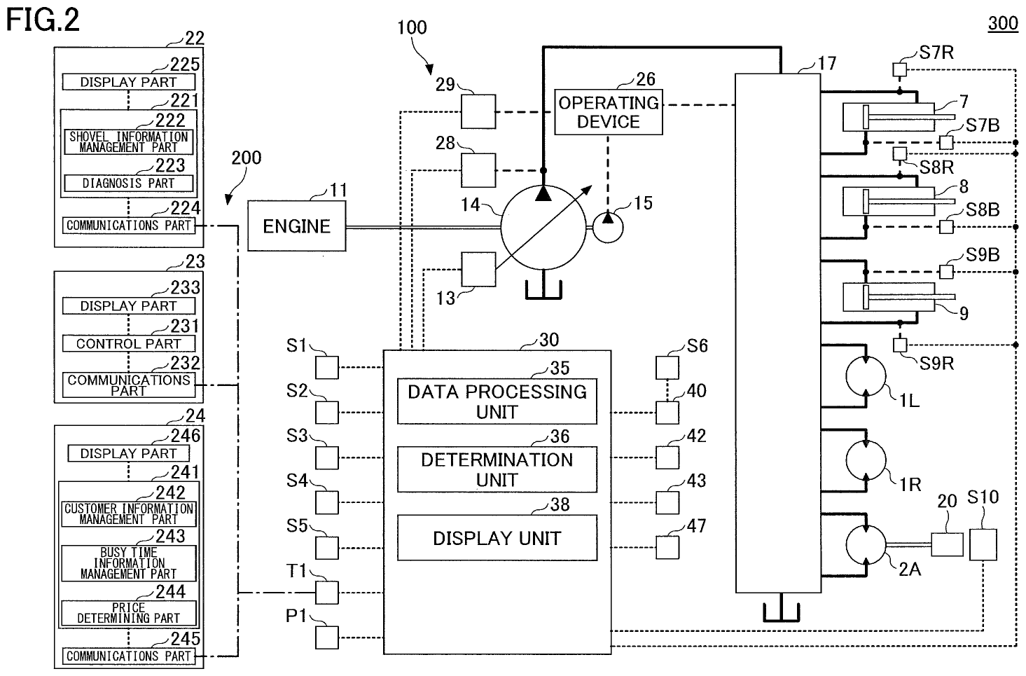

FIG. 2 is a block diagram illustrating an example configuration of the system 300 according to the embodiment. In FIG. 2, a mechanical power transmission line, a hydraulic oil line, a pilot line, an electrical control line, and a communications line are indicated by a double line, a solid line, a dashed line, a dotted line, and a one-dot chain line, respectively.

The basic system of the shovel 100 includes the engine 11, a regulator 13, a main pump 14, a pilot pump 15, a control valve unit 17, an operating device 26, a discharge pressure sensor 28, an operating pressure sensor 29, and the controller 30.

The engine 11 is a drive source of the shovel 100. According to this embodiment, the engine 11 is, for example, a diesel engine that operates in such a manner as to maintain a predetermined rotational speed. Furthermore, the output shaft of the engine 11 is coupled to the input shafts of the main pump 14 and the pilot pump 15.

The main pump 14 supplies hydraulic oil to the control valve unit 17 via a hydraulic oil line. According to this embodiment, the main pump 14 is a swash plate variable displacement hydraulic pump.

The regulator 13 controls the discharge quantity of the main pump 14. According to this embodiment, the regulator 13 controls the discharge quantity of the main pump 14 by controlling the swash plate tilt angle of the main pump 14 in response to a control command from the controller 30. For example, the controller 30 receives the output of the operating pressure sensor 29 or the like, and outputs a control command to the regulator 13 as required to change the discharge quantity of the main pump 14.

The pilot pump 15 supplies hydraulic oil to one or more hydraulic devices including the operating device 26 via a pilot line. According to this embodiment, the pilot pump 15 is a fixed displacement hydraulic pump.

The control valve unit 17 is a hydraulic control device that controls a hydraulic system in the shovel 100. According to this embodiment, the control valve unit 17 is configured as a valve block including multiple control valves. The control valve unit 17 can selectively supply hydraulic oil discharged by the main pump 14 to one or more hydraulic actuators via one or more control valves. The control valves control the flow rate of hydraulic oil flowing from the main pump 14 to the hydraulic actuators and the flow rate of hydraulic oil flowing from the hydraulic actuators to a hydraulic oil tank. The hydraulic actuators include the boom cylinder 7, the arm cylinder 8, the bucket cylinder 9, a left travel hydraulic motor 1L, a right travel hydraulic motor 1R, and a swing hydraulic motor 2A. The swing hydraulic motor 2A may be replaced with a swing motor generator serving as an electric actuator.

The operating device 26 is a device that the operator uses to operate actuators. The actuators include at least one of a hydraulic actuator and an electric actuator. According to this embodiment, the operating device 26 supplies hydraulic oil discharged by the pilot pump 15 to a pilot port of a corresponding control valve in the control valve unit 17 via a pilot line. The pressure of hydraulic oil supplied to a pilot port of a control valve (a pilot pressure) is a pressure commensurate with the direction of operation and the amount of operation of the operating device 26 corresponding to a hydraulic actuator associated with the control valve. The operating device 26 is configured to be able to supply hydraulic oil discharged by the pilot pump 15 to a pilot port of a corresponding control valve in the control valve unit 17 via a pilot line. The operating device 26 includes, for example, a left operating lever, a right operating lever, a left travel lever, and a right travel lever that are not depicted.

The discharge pressure sensor 28 detects the discharge pressure of the main pump 14. According to this embodiment, the discharge pressure sensor 28 outputs a detected value to the controller 30.

The operating pressure sensor 29 detects the details of the operator's operation using the operating device 26. According to this embodiment, the operating pressure sensor 29 detects the direction of operation and the amount of operation of the operating device 26 corresponding to each actuator in the form of pressure, and outputs a detected value to the controller 30. The operation details of the operating device 26 may also be detected using a sensor other than the operating pressure sensor 29.

The controller 30 includes a data processing unit 35, a determination unit 36, and a display unit 38 as functional elements. The individual functional elements, which are implemented as software according to this embodiment, may also be implemented as hardware, firmware, or the like.

The data processing unit 35 is configured to process information obtained by an information obtaining device. According to this embodiment, the data processing unit 35 processes the output data of the information obtaining device so that each of the determination unit 36 and a below-described diagnosis part 223 of the server 22 can use the output data of the information obtaining device. The information obtained by the information obtaining device includes at least one of the boom angle, the arm angle, the bucket angle, the roll angle, the pitch angle, the swing angular velocity, the swing angle, an image captured by the image capturing device S6, the boom rod pressure, the boom bottom pressure, the arm rod pressure, the arm bottom pressure, the bucket rod pressure, the bucket bottom pressure, the vibration of the swing reducer 20 detected by the vibration sensor S10, the detection value of a distortion sensor attached to the attachment or a frame, the discharge pressure of the main pump 14, an operating pressure associated with each operating device 26, etc. The information obtaining device includes at least one of the boom angle sensor S1, the arm angle sensor S2, the bucket angle sensor S3, the machine body tilt sensor S4, the swing angular velocity sensor S5, the image capturing device S6, the boom rod pressure sensor S7R, the boom bottom pressure sensor S7B, the arm rod pressure sensor S8R, the arm bottom pressure sensor S8B, the bucket rod pressure sensor S9R, the bucket bottom pressure sensor S9B, the vibration sensor S10, a distortion sensor (not depicted), the discharge pressure sensor 28, the operating pressure sensor 29, etc. The data processing unit 35 may be omitted if each of the determination unit 36 and the diagnosis part 223 can directly use data from the information obtaining device.

The data processing unit 35 is configured to retain the output data of the information obtaining device for a predetermined period. According to this embodiment, the data processing unit 35 temporarily records the output data of the information obtaining device in a nonvolatile storage medium. The data processing unit 35 may record the output data of the information obtaining device in the storage device 47.

The determination unit 36 is configured to determine whether a collection of data (hereinafter, “data set”) output by the information obtaining device is suitable for diagnosis performed by the diagnosis part 223 of the server 22. For example, the determination unit 36 determines whether a data set output by the vibration sensor S10 is suitable for diagnosis performed by the diagnosis part 223, in order to prevent a data set not suitable for diagnosis performed by the diagnosis part 223 from being fed to the diagnosis part 223.

The display unit 38 is configured to cause the display device 40 to display various kinds of information. According to this embodiment, the display unit 38 causes the display device 40 to display a predetermined screen in response to a command from the controller 30.

The server 22 includes a control part 221 that controls the operation of the server 22, a communications part 224, and a display (output) part 225. Furthermore, the control part 221 includes a shovel information management part 222 and the diagnosis part 223 as functional elements. The functional elements of the control part 221 may be either implemented as software or implemented as hardware, firmware, or the like.

The shovel information management part 222 is configured to store and manage a data set output by the information obtaining device. The data set is transmitted from the communications device T1 of the shovel 100 to be input to the shovel information management part 222 via the communications network 200 and the communications part 224. The result of a determination in the determination unit 36 may be appended to the data set transmitted from the communications device T1. Alternatively, only a data set that is determined to be suitable for diagnosis by the determination unit 36 may be transmitted from the communications device T1.

Furthermore, the shovel information management part 222 stores and manages the component replacement history of the shovel 100. The cumulative operating time of each component may be obtained from this component replacement history and the data set history. The cumulative operating time of a component is reset by replacing the component with a new component.

The diagnosis part 223 is configured to diagnose whether there is a sign of the failure of an inspection target based on a data set stored in the shovel information management part 222. Examples of inspection targets include the swing reducer 20 and the attachment. According to this embodiment, the diagnosis part 223 determines by diagnosis whether there is a sign of the failure of the swing reducer 20 based on a data set output by the vibration sensor S10. The swing reducer 20 is in a state of failure when the swing reducer 20 is not usable, the swing reducer 20 cannot withstand continuous use, or the like, for example. Examples of signs of the failure of the swing reducer 20 include a missing gear tooth in the planetary gear mechanism of the swing reducer 20 and the occurrence of irregular vibrations due to wear, damage, the eccentricity of a rotating shaft, or the like.

The communications part 224 is configured to be able to communicate with other devices or apparatuses through the communications network 200. The display part 225 is configured to display various kinds of information.

The communications terminal 23 includes a control part 231, a communications part 232, and a display (output) part 233. The control part 231 controls the operation of the communications terminal 23. The communications part 232 is configured to be able to communicate with other devices or apparatuses through the communications network 200. The display part 233 is configured to display various kinds of information.

The management server 24 includes a control part 241 that controls the operation of the management server 24, a communications part 245, and a display (output) part 246. The control part 241 includes a customer information management part 242, a busy time information management part 243, and a price determining part 244 as functional elements. The functional elements of the control part 241 may be either implemented as software or implemented as hardware, firmware, or the like.

The customer information management part 242 stores the correspondence between customers (users) and customer factors (preferred customer factors) used for price determination. A customer factor is a factor determined based on, for example, the number of shovels 100 possessed by a customer, maintenance frequency, etc. The customer factor may be lower for a customer possessing a larger number of shovels 100 than for a customer possessing a smaller number of shovels 100. Furthermore, the customer factor may be lower for a customer of a higher maintenance frequency than for a customer of a lower maintenance frequency.

The busy time information management part 243 stores the correspondence between seasons (time periods) and busy time factors used for price determination. For example, in the case of classifying seasons into the three levels of busy time information of a busy time, a normal time, and a slow time, the factor may be lower for the normal time than for the busy time, and may be lower for the slow time than for the busy time. For example, the busy time may be a season of increasing maintenance requests, such as the end of a fiscal year. The busy time may also be a season when the rate of operation of the shovel 100 increases.

The price determining part 244 determines a maintenance price based on information on the shovel 100 stored in the shovel information management part 222 of the server 22. Furthermore, the price determining part 244 determines the breakdown of replacement components and the number of working days for maintenance as information serving as a basis for the maintenance price. Furthermore, the price determining part 244 may also determine the number of workers needed and labor costs. A user can cause maintenance price information, etc., to be displayed on the display part 233 of the communications terminal 23 by accessing the management server 24 using the communications terminal 23, for example.

Here, the sum of the cost of a replacement component and labor charges is defined as a basic price. The basic price changes according to the cumulative operating time. For example, the basic price may increase as the cumulative operating time increases.

The maintenance price may be the basic price. The maintenance price may also be the product of the basic price and a customer factor in the customer information management part 242. The maintenance price may also be the product of the basic price and a busy time factor in the busy time information management part 243. That is, the maintenance price may be seasonally adjusted in terms of (by a factor representing) the degree of availability of maintenance service. The maintenance price may also be the product of the basic price, the customer factor, and the busy time factor.

The communications part 245 is configured to be able to communicate with other devices or apparatuses through the communications network 200. The display part 246 is configured to display various kinds of information.

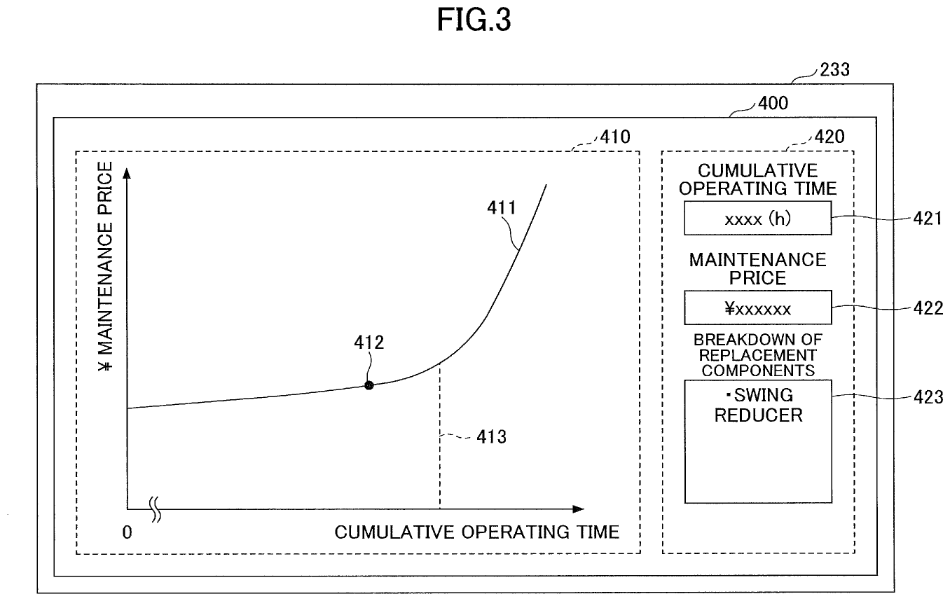

Next, an example display of a display screen generated by the maintenance support system 300 according to the embodiment is described with reference to FIG. 3. FIG. 3 illustrates an example of a display screen 400 according to the embodiment. The following description is given based on the assumption that the display screen 400 is displayed on the display part 233 of the communications terminal 23. The embodiment, however, is not limited to this configuration, and the display screen 400 may also be displayed on the display device 40 of the shovel 100, the display part 225 of the server 22, the display part 246 of the management server 24, etc. Furthermore, the display screen 400 illustrates an example in the case where the swing reducer 20 is an inspection target. Furthermore, FIG. 3 illustrates an example where the maintenance price is the basic price, namely, an example where neither the customer factor nor the busy time factor is used.

The display screen 400 includes a price change display part 410 and a breakdown display part 420.

In the price change display part 410, a price line 411 is displayed in a graph with the cumulative operating time on the horizontal axis and the maintenance price on the vertical axis. The price line 411, which is depicted as a continuous line, is not limited to this, and may be a discontinuous line that rises stepwise when a predetermined cumulative operating time is reached.

Furthermore, a symbol 412 indicating a current cumulative operating time and a current maintenance price is displayed in the price change display part 410. Referring to the example of FIG. 3, the symbol 412 is displayed as a black circle on the price line 411 corresponding to the current cumulative operating time.

Furthermore, a symbol 413 indicating a threshold time is displayed in the price change display part 410. Referring to the example of FIG. 3, the symbol 413 is displayed as a vertically extending dashed line at a position corresponding to the threshold time. Here, the threshold time is a threshold for determining that there is a risk of failure, for example, and is an operating time that serves as an indication of maintenance.

The price determining part 244 determines the maintenance price such that the maintenance price increases as the cumulative operating time increases as illustrated by the price line 411. Furthermore, the maintenance price slowly increases in a region where the cumulative operating time is less than the threshold time. In contrast, in a region where the cumulative operating time is more than or equal to the threshold time, the maintenance price more sharply increases than in the where the cumulative operating time is less than the threshold time.

The breakdown display part 420 includes a time display space (area) 421, a price display space (area) 422, and a breakdown display space (area) 423. A current cumulative operating time is displayed in the time display space 421. A current maintenance price is displayed in the price display space 422. The breakdown of components to be replaced and the number of working days for maintenance at the current moment are displayed as information serving as a basis for the maintenance price in the breakdown display space 423. The price information displayed in the price display space 422 may be the latest information transmitted from the management server 24. In this case, a price discounted according to a season may be displayed. For example, a discounted price may be displayed during a season when the rate of operation of a construction machine is low. Furthermore, by providing an entry field (not depicted) for entering the number of orders in the breakdown display space 423 and entering the number of orders, a price according to the number of purchases may be displayed in the price display space 422.

Furthermore, a field (not depicted) for entering purchase conditions and an inquiry button (not depicted) may be provided in the breakdown display part 420. By thus adding a field for entering purchase conditions and an inquiry button, it is possible to enter purchase conditions and make an inquiry to the management server 24. This makes it possible to display a price according to purchase conditions in the price display space 422. As the price information, not only a unit price but also purchase conditions may be displayed together. Furthermore, if a new replacement component is at hand, a request for a maintenance price excluding the cost of a component may be made to the management server 24. In this case, a maintenance price excluding the cost of a component is received from the management server 24 and displayed in the price display space 422.

Referring to the example illustrated in FIG. 3, a current cumulative operating time less than the threshold time is illustrated by way of example, and a “swing reducer” is displayed as the breakdown of replacement components in the breakdown display space 423. When the cumulative operating time is more than or equal to the threshold time, the “swing reducer” and a “sealing component” are displayed as the breakdown of replacement components in the breakdown display space 423. Furthermore, when there is damage, the “swing reducer,” the “sealing component,” and a “swing motor” are displayed as the breakdown of replacement components and the number of working days such as “two-day work” is displayed in the breakdown display space 423.

For example, it is supposed that a gear in a swing reducer is worn to generate metal powder and that the metal powder mixes with a lubricant. The mixture of the metal powder with the lubricant reduces the useful service life of a sealing member. Therefore, while only the “swing reducer” is replaced when the cumulative operating time is less than the threshold time, the “swing reducer” and the “sealing component” are replaced when the cumulative operating, time is more than or equal to the threshold time. Furthermore, in the case of a damaged swing reducer, another associated component (a swing motor) is affected when the swing reducer is damaged. Therefore, in a damaged condition, the number of replacement components further increases and the number of working days also increases. Furthermore, the number of workers engaged in work also increases to raise labor costs. Accordingly, when displaying the maintenance price, the maintenance support system 300 displays replacement components and the number of working days according to the state or condition of an inspection target as information serving as a basis for the maintenance price in the breakdown display space 423. Furthermore, the number of workers needed and labor costs may also be displayed.

Thus, according to the maintenance support system 300, as illustrated in FIG. 3, the maintenance price and the cumulative operating time of the shovel 100 may be displayed in association with each other. This enables a user to determine the timing of maintenance of the shovel 100 based on the displayed information.

Furthermore, according to the maintenance support system 300, the maintenance price (basic price) may be determined such that the price increases as the cumulative operating time increases, and the determined maintenance price may be displayed on the display part 233 of the communications terminal 23, etc. This serves as an incentive for a user to advance the timing of maintenance ahead of the threshold time.

Here, according to a method of determining a maintenance price based on the costs of components and labor charges regardless of the usage of an inspection target, replacement may be made after the occurrence of failure irrespective of the progress of fatigue of the inspection target. Therefore, a serviceperson has to rush to respond, and the occurrence of unplanned downtime due to the failure reduces work efficiency.

In contrast, according to the system 300 of the embodiment, the maintenance price is determined based on the cumulative operating time of an inspection target. This encourages a user who possesses the shovel 100 to replace the inspection target early to prevent the occurrence of unplanned downtime, thus making it possible to prevent a decrease in work efficiency. Furthermore, because it is possible to reduce the frequency of rushed response, it is possible to reduce downtimes such as a period of time for securing maintenance workers and a period of time for waiting for the arrival of backordered replacement components.

Furthermore, the maintenance price may be multiplied by the busy time factor. In this case, the maintenance price may be determined such that the price is lower for the slow time than for the busy time, and the determined maintenance price may be displayed on the display part 233 of the communications terminal 23, etc. This makes it possible for a user to reduce maintenance costs by performing maintenance during the slow time. Furthermore, performing maintenance during the slow time makes it easier to ensure the schedule of maintenance workers.

Furthermore, the maintenance price may be multiplied by the customer factor. This makes it possible to determine the maintenance price according to the status of a user and to display the determined maintenance price on the display part 233 of the communications terminal 23, etc.

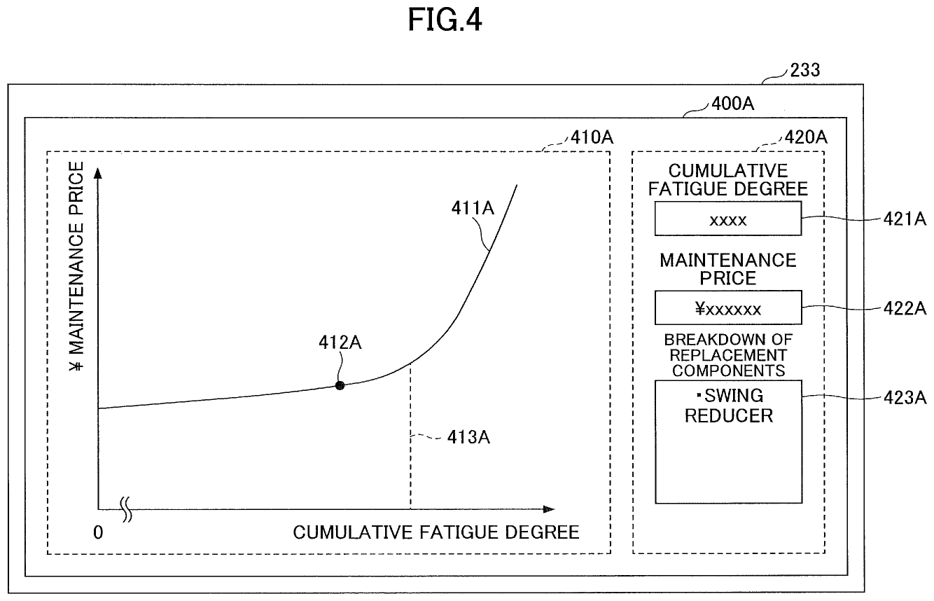

The maintenance support system 300 according to another embodiment is described with reference to FIGS. 4 through 7. The system 300 of this embodiment may have the same configuration as the system 300 illustrated in FIGS. 1 and 2. Accordingly, duplicate description of the configuration is omitted.

Next, an example display of a display screen generated by the maintenance support system 300 of this embodiment is described with reference to FIG. 4. FIG. 4 illustrates an example of a display screen 400A of this embodiment. The display screen 400A may be displayed on the display device 40 of the shovel 100, the display part 225 of the server 22, the display part 233 of the communications terminal 23, the display part 246 of the management server 24, etc. Furthermore, the display screen 400A illustrates an example in the case where the swing reducer 20 is an inspection target. Furthermore, FIG. 4 illustrates an example where the maintenance price is the basic price, namely, an example where neither the customer factor nor the busy time factor is used.

The display screen 400A includes a price change display part 410A and a breakdown display part 420A. In the price change display part 410A, a price line 411A is displayed in a graph with the degree of cumulative fatigue on the horizontal axis and the maintenance price on the vertical axis. Here, the degree of cumulative fatigue is a value obtained as a result of diagnosis performed by the diagnosis part 223, and is described in detail below. According to this embodiment, the basic price of the price determining part 244 changes according to the degree of cumulative fatigue. For example, the basic price may increase as the degree of cumulative fatigue increases. The horizontal axis does not have to use the degree of cumulative fatigue as the result of diagnosis as long as the horizontal axis is an evaluation scale pertaining to damage. Furthermore, the price line 411A, which is depicted as a continuous line, is not limited to this, and may be a discontinuous line that rises stepwise when reaching a predetermined degree of cumulative fatigue.

Furthermore, a symbol 412A indicating a current degree of cumulative fatigue and a current maintenance price is displayed in the price change display part 410A. Referring to the example of FIG. 4, the symbol 412A is displayed as a black circle on the price line 411A corresponding to the current degree of cumulative fatigue. Furthermore, a symbol 413A indicating a threshold degree of fatigue is displayed in the price change display part 410A. Referring to the example of FIG. 4, the symbol 413A is displayed as a vertically extending dashed line at a position corresponding to the threshold degree of fatigue. Here, the threshold degree of fatigue is a threshold for determining that there is a risk of failure, for example, and is a value that serves as an indication of maintenance.

The breakdown display part 420A includes a fatigue degree display space (area) 421A where a current degree of cumulative fatigue is displayed, a price display space (area) 422A where a current maintenance price is displayed, and a breakdown display space (area) 423A where the breakdown of components to be replaced for maintenance at the current moment is displayed.

That is, the example illustrated in FIG. 4 differs in determining the maintenance price with respect to the degree of cumulative fatigue from the example illustrated in FIG. 3, which determines the maintenance price with respect to the cumulative operating time.

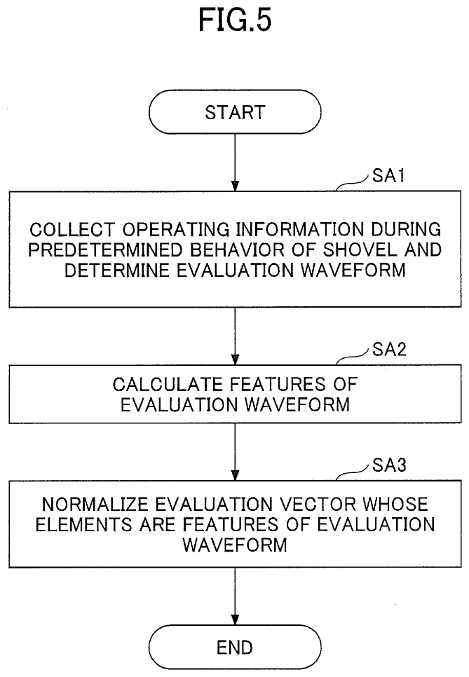

Here, the principle of calculation of the degree of cumulative fatigue is described with reference to FIGS. 5 through 7. The description is given based on the assumption that the diagnosis part 223 performs operations for the degree of cumulative fatigue.

FIG. 5 is a flowchart of a process executed by the diagnosis part 223.

At step SA1, the diagnosis part 223 obtains the operating information of the shovel 100 (one or more data sets output by the information obtaining device) at regular time intervals during the predetermined behavior of the shovel 100. The predetermined behavior is a motion or operation selected from various motions or operations of the shovel 100 during its operation. Examples of the predetermined behavior include an idling operation, a hydraulic pressure relieving operation, a boom raising motion, a boom lowering motion, a swing motion, a forward moving motion, and a backward moving motion. Changes over time in an obtained data set are referred to as “evaluation waveform.” According to this embodiment, the swing reducer 20 is an inspection target, and the predetermined behavior is the clockwise swing motion of the upper swing structure 3. Furthermore, at this point, one or more of the swing torque (swing motor pressure) of the swing hydraulic motor 2A, the rotational acceleration of the swing hydraulic motor 2A, the temperature of the swing reducer 20, the oil condition (metal powder density or the like) of the swing reducer 20, etc., may be obtained and used as the operating information.

At step SA2, the diagnosis part 223 calculates features from the evaluation waveform. The “features” mean various statistics that characterize the shape of the waveform. For example, an average, a standard deviation, a maximum peak value, the number of peaks, the maximum value of a signal absence period, etc., may be employed as the features.

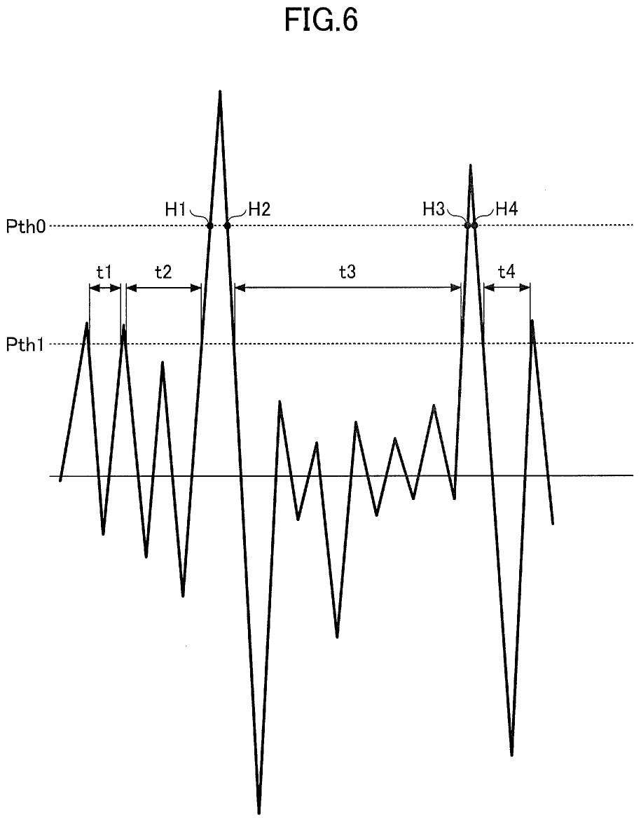

The number of peaks and the maximum value of a signal absence period are described with reference to FIG. 6. FIG. 6 illustrates part of an evaluation waveform as an example. The “number of peaks” is defined as the number of crossing points of a waveform and a threshold Pth0, for example. During the period illustrated in FIG. 6, the waveform crosses the threshold Pth0 at crossing points H1 through H4. Therefore, the number of peaks calculated is four.

An interval where the waveform is lower than the threshold Pth1 is defined as “signal absence interval.” Referring to the example illustrated in FIG. 6, there are signal absence intervals t1 through t4. The “maximum value of a signal absence period” means a maximum duration among the durations of signal absence intervals. Referring to the example of FIG. 6, the duration of the signal absence interval t3 is employed as the maximum value of a signal absence period. In general, when a waveform includes a long-period swell, the maximum value of a signal absence period is large.

Referring back to FIG. 5, at step SA3, a normalized evaluation vector is determined by normalizing an evaluation vector whose elements are the features of an evaluation waveform. Steps for normalizing the evaluation vector is described below.

Operating variables during the predetermined behavior of the shovel 100 in its normal condition are collected in advance. Multiple time waveforms are clipped from the operating variables collected over a certain period. These time waveforms are referred to as “reference waveforms.” Features are calculated with respect to each reference waveform. Reference vectors whose elements are the features of the individual reference waveforms are obtained. Normalized reference vectors are obtained by normalizing the reference vectors such that the average is 0 and the standard deviation is 1 with respect to each of the features of the reference vectors. The average and the standard deviation of each of the features of the reference vectors are used in this normalization. The average and the standard deviation of a feature i are expressed as m(i) and σ(i), respectively.

The evaluation vector is normalized using the average m(i) and the standard deviation σ(i) of the feature i of the reference vectors. Letting the feature i of the evaluation vector be expressed as a(i), the feature i of the normalized evaluation vector is expressed as (a(i)−m(i))/σ(i). When the shape of the evaluation waveform is close to the shape of the reference waveforms, each feature (i) of the normalized evaluation vector is close to 0, and when there is a large difference between the shape of the evaluation waveform and the shape of the reference waveforms, the absolute value of the feature (i) of the normalized evaluation vector is large.

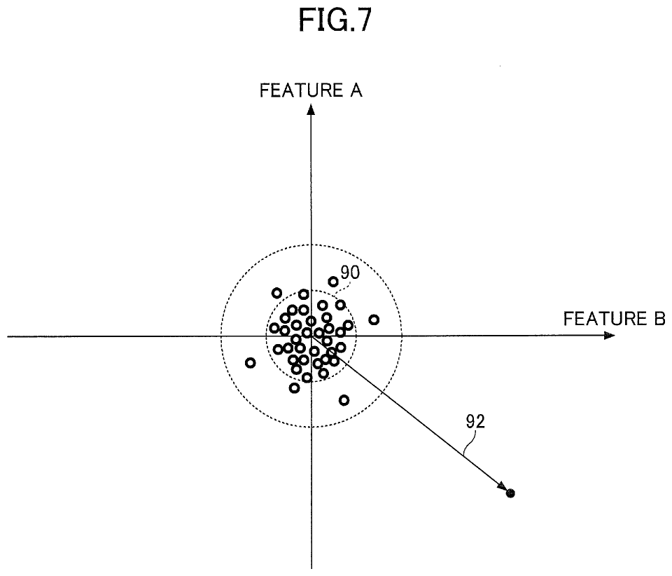

FIG. 7 illustrates an example of a distribution of normalized reference vectors and a normalized evaluation vector 92. While FIG. 7 illustrates a distribution of normalized reference vectors in a two-dimensional plane with respect to two features A and B, the normalized reference vectors and the normalized evaluation vector are actually distributed in a vector space having a dimension corresponding to the number of features (i). The end point of a normalized reference vector is represented by a hollow circle symbol. Approximately 68% of the normalized reference vectors are distributed within a sphere 90 of a radius of 1σ. Here, σ represents a standard deviation, and the standard deviation σ is 1 because each feature is normalized.

The absolute value of the normalized evaluation vector 92 thus determined is defined as the degree of cumulative fatigue, which is an example of a numerical value indicating the possibility of failure.

Thus, according to the maintenance support system 300 of this embodiment, the maintenance price and the degree of cumulative fatigue of the shovel 100 may be correlated and displayed as illustrated in FIG. 4. This enables a user to determine the timing of maintenance of the shovel 100 based on the displayed information. Furthermore, it is possible to prevent the occurrence of unplanned downtime due to failure and accordingly to prevent a decrease in work efficiency due to the occurrence of unplanned downtime.

Furthermore, according to this embodiment, it is possible to determine the maintenance price based on the degree of cumulative fatigue and to display the determined maintenance price on the display part 233 of the communications terminal 23, etc. This makes it possible to suitably make a determination as to maintenance based on the displayed information as illustrated in FIG. 4 even when the operation is such that heavy load work is repeatedly performed to cause wear to progress faster than expected.

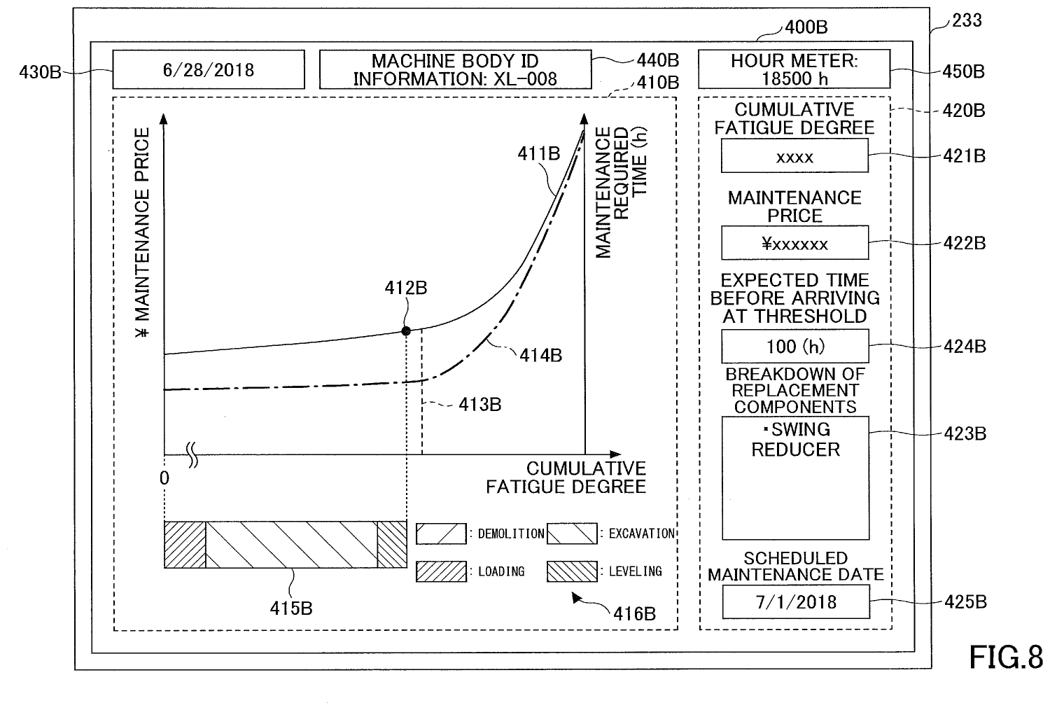

Next, another example display of the display screen generated by the maintenance support system 300 according to this embodiment is described with reference to FIG. 8. FIG. 8 illustrates an example of a display screen 400B. The display screen 400B may be displayed on the display device 40 of the shovel 100, the display part 225 of the server 22, the display part 233 of the communications terminal 23, the display part 246 of the management server 24, etc. Furthermore, the display screen 400B illustrates an example in the case where the swing reducer 20 is an inspection target. Furthermore, FIG. 8 illustrates an example where the maintenance price is the basic price, namely, an example where neither the customer factor nor the busy time factor is used.

The display screen 400B includes a price change display part 410B and a breakdown display part 420B. In the price change display part 410B, a price line 411B is displayed in a graph with the degree of cumulative fatigue on the horizontal axis and the maintenance price on a vertical axis (on the left). Furthermore, a time line 414B is displayed in a graph with a maintenance required time on a second vertical axis (on the right). The time line 414B indicates the time required for the maintenance of an inspection target. Here, the degree of cumulative fatigue is a value obtained as a result of diagnosis performed by the diagnosis part 223 as described above. According to this embodiment, the basic price of the price determining part 244 changes according to the degree of cumulative fatigue. For example, the basic price may increase as the degree of cumulative fatigue increases. The horizontal axis does not have to use the degree of cumulative fatigue as the result of diagnosis as long as the horizontal axis is an evaluation scale pertaining to damage. Furthermore, each of the price line 411B and the time line 414B, which is depicted as a continuous line, is not limited to this, and may be a discontinuous line that rises stepwise when reaching a predetermined degree of cumulative fatigue.

Furthermore, a symbol 412B indicating a current degree of cumulative fatigue and a current maintenance price is displayed in the price change display part 410B. Referring to the example of FIG. 8, the symbol 412B is displayed as a black circle on the price line 411B corresponding to the current degree of cumulative fatigue. Furthermore, a symbol 413B indicating a threshold degree of fatigue is displayed in the price change display part 410B. Referring to the example of FIG. 8, the symbol 413B is displayed as a vertically extending dashed line at a position corresponding to the threshold degree of fatigue. Here, the threshold degree of fatigue is a threshold for determining that there is a risk of failure, for example, and is a value that serves as an indication of maintenance.

Thus, the maintenance price and the degree of cumulative fatigue of the shovel 100 may be correlated and displayed, and the time required for maintenance and the degree of cumulative fatigue of the shovel 100 may be correlated and displayed. This enables a user to determine the timing of maintenance of the shovel 100 based on the displayed information.

Furthermore, a work details history 415B and an explanatory note 416B are displayed in the price change display part 410B. In the work details history 415B, the degree of cumulative fatigue up to the present is broken down into work details illustrated in the explanatory note 416B and is displayed as a stacked bar graph. Referring to the example illustrated in FIG. 8, demolition, excavation, loading, and leveling are displayed in the explanatory note 416B.

For example, the controller 30 determines to which one of the work details illustrated in the explanatory note 416B the work details of the shovel 100 correspond, based on the motion of the shovel 100 detected with the pose sensor (the boom angle sensor S1, the arm angle sensor S2, the bucket angle sensor S3, the machine body tilt sensor S4, the swing angular velocity sensor S5, etc.) of the shovel 100 or an image captured by the image capturing device S6. The degree of fatigue accumulated in the shovel 100 in each work is added up for each of the work details illustrated in the explanatory note 416B. The breakdown of the degree of cumulative fatigue thus obtained is displayed in the work details history 415B.

This enables a user to easily understand by what work the degree of fatigue is accumulated based on the information displayed in the work details history 415B.

The breakdown display part 420B includes a fatigue degree display space (area) 421B where a current degree of cumulative fatigue is displayed, a price display space (area) 422B where a current maintenance price is displayed, a breakdown display space (area) 423B where the breakdown of components to be replaced for maintenance at the current moment is displayed, an expected arrival time display space (area) 424B where an expected time before arriving at a threshold (threshold degree of fatigue) is displayed, and a scheduled maintenance date entry field 425B for entering a scheduled maintenance date.

Furthermore, the display screen 400B includes a date display space (area) 430B where a current date is displayed, a machine body identification information display space 440B (area) where the identification information of the shovel 100 corresponding to the information displayed in the price change display part 410B and the breakdown display part 420B is displayed, and an hour meter display space (area) 450B where the hour meter (cumulative operating time) of the shovel 100 is displayed.

This enables a user to plan the maintenance of the shovel 100 based on the information displayed on the display screen 400B. In other words, the display screen 400B can assist a user in creating a maintenance plan of the shovel 100.

Furthermore, when a user enters a scheduled maintenance date in the scheduled maintenance date entry field 425B, the scheduled maintenance date may be transmitted to the management server 24. As a result, maintenance is booked. Furthermore, the identification information of the shovel 100 in the machine body identification information display space 440B, an hour meter in the hour meter display space 450B, the degree of cumulative fatigue in the fatigue degree display space 421B, a maintenance price in the price display space 422B, the breakdown of components to be replaced in the breakdown display space 423B, etc., may also be transmitted to the management server 24 together with the scheduled maintenance date.

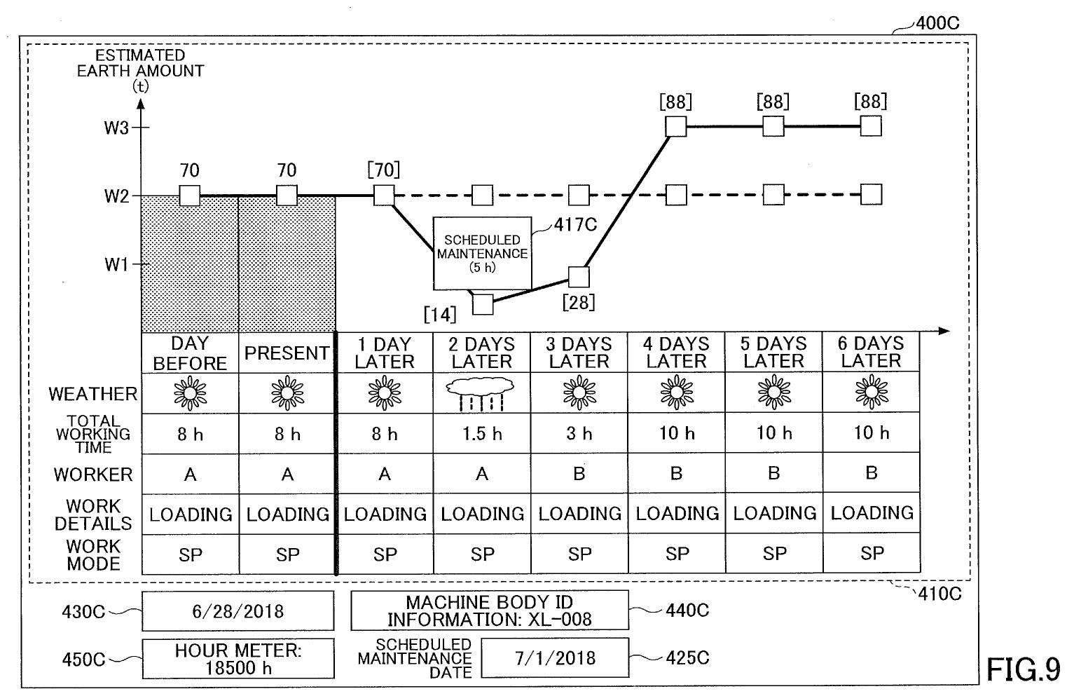

Next, yet another example display of the display screen generated by the maintenance support system 300 according to this embodiment is described with reference to FIG. 9. FIG. 9 illustrates a display screen 400C.

Referring to FIG. 9, in a display part 410C of the display screen 400C, daily changes in the estimated amount of earth are displayed in a bar graph, and daily changes in the target value (planned value) of a workload (the estimated amount of earth) are displayed in a line graph. Of the line graph, a solid line represents a target value (planned value) after the change of a plan, a dashed line represents a target value (planned value) before the change of a plan. The display part 4100 further displays each day's weather, total working time, a worker, the type of work details, and a rotational speed mode in a table format. Furthermore, the number of dump trucks associated with carrying out an excavated object is displayed above the bar graph in the display part 410C.

Specifically, the display part 410C shows, with respect to, for example, the work of the day before, that the weather is “fine,” that the total working time is “eight hours,” that the worker is “A,”, that the type of work details is “loading (motion),” that the rotational speed mode is “SP,” that the target value of a daily workload is W2[t], that the actual workload (estimated amount of earth) is the same as the target value of W2[t], and that the number of dump trucks carrying out an excavated object of a work site is 70.

Furthermore, the display part 410C shows, with respect to, for example, the work of five days later, that the weather is “fine,” that the total working time is “ten hours,” that the worker is “B,”, that the type of work details is “loading (motion),” that the rotational speed mode is “SP,” that the target value of a daily workload is changed from W2[t] to W3[t], that the number of dump trucks required to carry out an excavated object of a work site is 88.

Referring to the example illustrated in FIG. 9, information on the past (the day before) and the present represent actual achievements and information on the future represents predictions.

A manager who looks at this display part 410C can understand, with respect to, for example, the work of the day before, that the loading of an excavated object into dump trucks has been performed as intended (as planned). Furthermore, with respect to the work of two days later, the manager expects that the loading of an excavated object into dump trucks will not be performed as intended due to rain. Furthermore, with respect to the work of three days later, the manager expects that the loading of an excavated object into dump trucks will not be performed as intended because part of the excavated object (earth) is not dry enough to be carried out in spite of fine weather.

Furthermore, the manager looking at this display part 410C can understand, for example, that the target value of a daily workload is raised from W2[t] to W3[t] with respect to the next day (four days later) and thereafter in order to make up for the delay in work. The bracketed value of the number of dump trucks is a value after the change.

This enables the manager to simultaneously check the amount of earth to be loaded (workload) per day required to make up for a delay in a process (schedule) and the number of dump trucks to be arranged for to carry out the earth and also to understand that the planned values are changed because of a weather change. In addition to weather information, the display part 410C may also display information on a machine condition. The machine condition is, for example, at least one of “normal,” “minor failure, and “abnormal.” When “abnormal” is displayed as the machine condition, the manager can understand that a workload decrease is caused by the abnormality of the machine (the shovel 100). Furthermore, the display part 410C may also display a work site situation. The work site situation is, for example, at least one of “a worker's absence from work (break),” “an accident,” “a machine's traveling,” “a misplaced material,” and “an inspection (survey).” The manager looking at the work site situation understands that a workload decrease is caused by a change in the work site situation, such as the occurrence of an “accident.”

Furthermore, the display screen 400C includes a date display space (area) 430C in which a current date is displayed, a machine body identification information display space (area) 440C where the identification information of the shovel 100 corresponding to the information displayed in the display part 410C is displayed, an hour meter display space (area) 450C where the hour meter (cumulative operating time) of the shovel 100 is displayed, and a scheduled maintenance date entry field 425C for entering a scheduled maintenance date.

This enables a user to plan the maintenance of the shovel 100 based on the information displayed on the display screen 400C. In other words, the display screen 400C can assist a user in creating a maintenance plan of the shovel 100. For example, a user creates a scheduled maintenance date based on the weather information displayed in the display part 410C. For example, maintenance is scheduled for a rainy day when the shovel 100 is unable to work. Furthermore, a user creates a scheduled maintenance date based on the scheduled total working time displayed in the display part 410C. For example, maintenance is scheduled for a day when the total working time is short.

Furthermore, when a user enters a scheduled maintenance date in the scheduled maintenance date entry field 425C, scheduled maintenance information 417C is displayed in the display part 410C. The scheduled maintenance information 417C is displayed, being stacked on the target value of the scheduled maintenance date. According to this example, it is indicated on the day before that the maintenance of the shovel 100 is scheduled to be performed after the shovel 100 performs work commensurate with a workload (the estimated amount of earth) shown in the bar graph.

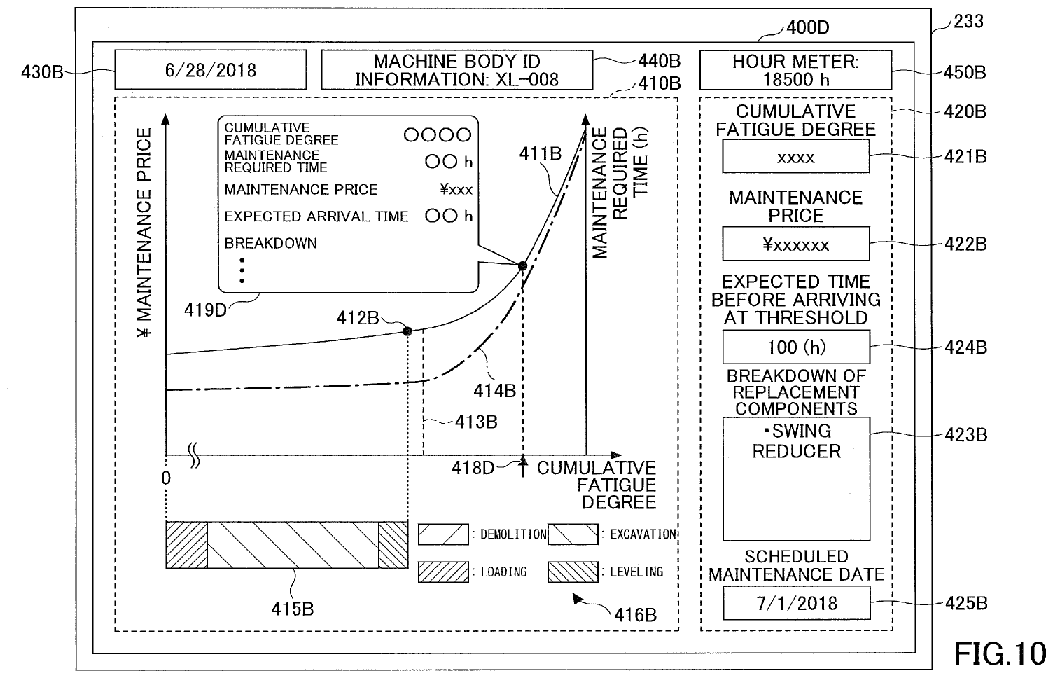

Next, still another example display of the display screen generated by the maintenance support system 300 according to this embodiment is described with reference to FIG. 10. FIG. 10 illustrates an example of a display screen 400D.

Like the display screen 400B illustrated in FIG. 8, the display screen 400D includes the price change display part 410B, the breakdown display part 420B, the date display space 430B, the machine body identification information display space 440B, and the hour meter display space 450B.

In addition, a slider 418D that can be moved by a user's operation is displayed in the price change display part 410B of the display screen 400D. For example, the slider 418D is movable along the horizontal axis of the graph. By sliding the slider 418D, various kinds of information at the degree of cumulative fatigue selected by the slider 418D are displayed in a balloon 419D. The balloon 419D may be a pop-up.

Examples of various kinds of information displayed in the balloon 419D include the degree of cumulative fatigue selected by the slider 418D, the time required for maintenance at the selected degree of cumulative fatigue, a maintenance price at the selected degree of cumulative fatigue, an expected arrival time (an expected time before arriving at the threshold), and a breakdown (the breakdown of replacement components).

This enables a user to plan the maintenance of the shovel 100 based on the information displayed on the display screen 400D. In other words, the display screen 400D can assist a user in creating a maintenance plan of the shovel 100.

The slider 418D, which is described as being movable along the horizontal axis of the graph according to the example of FIG. 10, is not limited to this, and may be configured to move along the vertical axes (the first vertical axis and the second vertical axis) of the graph.

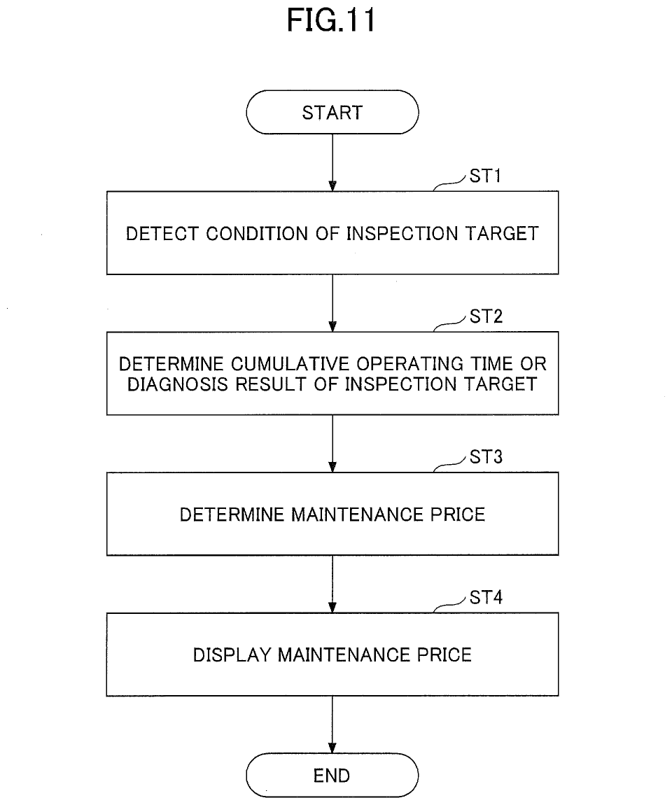

FIG. 11 is a flowchart of an information output method for a construction machine according to an embodiment of the present invention.

At step ST1, the condition of an inspection target of the shovel 100, such as the swing reducer 20, is detected with one or more information obtaining devices, which may be various sensors and image capturing devices such as those described above. In place of the image capturing device S6, a space recognition device such as a LIDAR device may be employed. The shovel information management part 222 is configured to store and manage a data set output by one or more information obtaining devices.

At step ST2, the cumulative operating time of the inspection target or the result of the diagnosis of the condition of the inspection target is determined based on the result of the detection of step ST1. As described above, the cumulative operating time of each component of the shovel 100 may be obtained from the component replacement history and the data set history stored and managed by the shovel information management part 222. Furthermore, the diagnosis part 223 diagnoses whether there is a sign of the failure of the inspection target based on the data set stored in the shovel information management part 222.

Next, at step ST3, a maintenance price associated with the cumulative operating time or the diagnosis result is determined. As described above, the price determining part 244 determines a maintenance price based on information on the shovel 100 stored in the shovel information management part 222 of the server 22. Here, the price determining part 244 determines the maintenance price such that the maintenance price increases as the cumulative operating time increases. Furthermore, the maintenance price may be the basic price, and the basic price of the price determining part 244 changes according to the degree of cumulative fatigue.

Next, at step ST4, the determined maintenance price is displayed. As described above, the maintenance price may be displayed on, for example, the display part 233 of the communications terminal 23, the display device 40 of the shovel 100, the display part 225 of the server 22, the display part 246 of the management server 24, etc.

Embodiments of the present invention are described in detail above. The present invention, however, is not limited to the specifically disclosed embodiments, and variations and substitutions may be made without departing from the scope of the present invention. Furthermore, the separately described features may be combined to the extent that no technical contradiction is caused.

For example, the diagnosis part 223, which is described as being provided in the server 22, may be provided in the controller 30 of the shovel 100 or in the control part 241 of the management server 24. In this case, the controller 30 or the control part 241 may access the shovel information management part 222 of the server 22 for the information such as data sets stored in the shovel information management part 222. Furthermore, one or more functions of the server 22 and one or more functions of the management server 24 may be implemented in a single server that serves as an assist device for the shovel 100. Furthermore, the control part 231 of the communications terminal 23 may be configured to include the functions of the diagnosis part 223 and the price determining part 244. In this case, the control part 231 may access the shovel information management part 222 of the server 22 for the information such as data sets stored in the shovel information management part 222.

The maintenance price, which is described as visual information displayed on the display part 233 of the communications terminal 23, etc., is not limited to this configuration, and may also be output as audio information together with or instead of visual information. The same applies to the information serving as a basis for the maintenance price. In this case, the audio information may be output through an audio output device of the communications terminal 23, etc. Furthermore, the information output method of the display part 233 is not limited to a display method using a liquid crystal screen as illustrated in FIG. 3, etc., and may also be a display method using a display lamp, etc.

What is claimed is:

1. An information output method for a construction machine, the information output method comprising:
detecting a condition of an inspection target of the construction machine with an information obtaining device;
determining a cumulative operating time of the inspection target or a diagnosis result of the condition of the inspection target based on a result of said detecting;
determining a maintenance price associated with the cumulative operating time or the diagnosis result; and
outputting the determined maintenance price,
wherein said determining the cumulative operating time or the diagnosis result, said determining the maintenance price, and said outputting the determined maintenance price are executed by one or more hardware processors.

2. The information output method as claimed in claim 1, wherein
the diagnosis result is expressed as a numerical value indicating a possibility of a failure of the inspection target,
the maintenance price is determined based on a basic price, and
the basic price increases as the cumulative operating time or the numerical value of the diagnosis result increases.

3. The information output method as claimed in claim 1, wherein the maintenance price is calculated based on busy time information.

4. The information output method as claimed in claim 1, wherein information serving as a basis for the maintenance price is output together with the maintenance price.

5. The information output method as claimed in claim 1, wherein the maintenance price is output as at least one of visual information and audio information.

6. An assist device for a construction machine, the assist device comprising:
a hardware processor configured to
obtain information on a condition of an inspection target of the construction machine,
determine a cumulative operating time of the inspection target or a diagnosis result of the condition of the inspection target based on the obtained information,
determine a maintenance price associated with the cumulative operating time or the diagnosis result, and
outputting the determined maintenance price.

7. The assist device as claimed in claim 6, wherein
the diagnosis result is expressed as a numerical value indicating a possibility of a failure of the inspection target,
the maintenance price is determined based on a basic price, and
the basic price increases as the cumulative operating time or the numerical value of the diagnosis result increases.

8. The assist device as claimed in claim 6, wherein the maintenance price is calculated based on busy time information.

9. The assist device as claimed in claim 6, wherein information serving as a basis for the maintenance price is output together with the maintenance price.

10. The assist device as claimed in claim 6, wherein the maintenance price is output as at least one of visual information and audio information.
